(19) United States
(12) Patent Application Publication
(10) Pub. No.: US 2026/0234484 A1
(43) Pub. Date: Aug. 13, 2026

(54) BIOMASS GASIFICATION GAS TREATMENT APPARATUS

(71) Applicant: BIOMASS ENERGY CORPORATION, Nagasaki (JP)

(72) Inventors: Takeshi SUZUKI, Nagasaki (JP); Takashi MITANI, Nagasaki (JP); Eiichirou HOSHINO, Nagasaki (JP); Mitsunori HIRAMOTO, Nagasaki (JP)

(21) Appl. No.: 18/880,523

(22) PCT Filed: Mar. 13, 2024
(86) PCT No.: PCT/JP2024/009859

§ 371 Date: Sep. 30, 2025

(30) Foreign Application Priority Data
Mar. 13, 2023 (WO) PCT/JP2023/009684

(51) Int. Cl. C10J 3/84; B01D 21/26; B01D 47/02; B01D 47/06; C10K 1/10

(52) U.S. Cl. CPC C10J 3/84; B01D 21/262; B01D 47/021; B01D 47/06; C10K 1/101; C10J 2300/0916; C10J 2300/1603

(57) ABSTRACT

Until now, tar components that are by-products of biomass gasification have not been effectively utilized as highly adhesive mediators. The present disclosure provides an apparatus for treating biomass gas obtained by gasifying biomass. The apparatus comprises: a cooling/cleaning unit for cooling and cleaning the biomass gas with a cleaning liquid; a recovery unit for recovering the cleaning liquid; and a separation unit for extracting tar in the recovered cleaning liquid by using specific gravity separation. The cooling/cleaning unit includes an inlet chamber for initially receiving the biomass gas and an outlet chamber for receiving the biomass gas that has passed through the inlet chamber.

### TECHNICAL FIELD

The present disclosure relates to an apparatus and method for treating a biomass gasification gas (also described herein as “biomass gas”). In particular, the present disclosure relates to an apparatus and method for cooling and cleaning the biomass gas and recovering organic compounds (in particular, tar) contained in the biomass gas.

The present invention relates to an apparatus for gasification that uses thermal energy to subject a target of gasification to thermochemical endothermic reaction. Specifically, the target of gasification contains organic compounds as the main component, more specifically the organic compound is a so-called biomass of herbs and trees or the like, or an organic waste such as agricultural or food organic waste, a plant-based waste plastic, or a plant waste oil. The present invention relates to a reaction apparatus or a reactor for gasifying these organic compounds through endothermic reaction to obtain a biomass gasification gas containing hydrogen and carbon monoxide as the main components, and relates to an apparatus for cooling and cleaning the biomass gasification gas to recover the organic compounds contained.

### BACKGROUND ART

Thus far, energy conversion of solid biomass was mainly heat utilization by direct combustion. However, in such energy conversion by direct combustion using solid biomass as fuel, efficient energy utilization has been difficult. For example, when power is generated using heat generated by direct combustion of a solid biomass fuel, water vapor turbine power generation is adopted in which water vapor is generated using wood chip and a boiler, and a turbine is rotated by the water vapor energy to generate power. However, without a large plant, actually, the power generation efficiency is lowered, and the economic efficiency is low. In addition, a solid biomass fuel has poor storage stability due to changes in dryness caused by moisture absorption; and has a low energy density, and thus occupies a large volume, making it unsuitable for transportation and storage, thereby lacking versatility.

As is clear from these facts, compared with thermal utilization by direct combustion, conversion of solid biomass into liquid fuel or chemical substances is a more effective method for effectively utilizing biomass energy, and conversion of biomass into liquid fuel and chemical raw material is a promising technology in the future for realization of the production of CO₂-Free non-fossil fuel-derived chemical raw material and fuel.

From this viewpoint, a technology to convert biomass into liquid fuel, in which solid biomass is directly converted into liquid fuel, has been developed. This technology is a so-called fermentation technique using microorganisms. In this technique, only components such as carbohydrate and starch in the raw material biomass are used to obtain a liquid fuel containing ethanol as the main component by subjecting these components to microbial fermentation.

However, this technique has a problem that the portion other than the components such as carbohydrate and starch in biomass used as a raw material are wasted due to the inability to be converted into fuel. In addition, as a raw material biomass for efficiently obtaining carbohydrate and starch, edible plants such as sugar cane and corn or the like are mainly suitable, and thus its competition with food utilization becomes a problem. In these respects, biodiesel fuel obtained by esterifying various plant oils with added methanol has similar problems.

In view of these conventional problems, namely the low conversion efficiency of biomass energy, the lack of versatile applicability, and the competition between raw material biomass and food, gasification technologies have been developed to date as the core technology for advanced use of biomass-based energy. In the gasification technology, various kinds of biomass are used as a raw material to be gasified in order to generate a biomass gasification gas that can be used as a fuel gas or a biomass gasification gas that enables the synthesis of required liquid fuel.

Conventional examples of gasification technology include a so-called partial oxidation gasification technology. The core of these conventional gasification technologies is to employ a method for generating heat of reaction by partial-combusting biomass in the same space (reaction space) at no more than the theoretical amount of air or oxygen (partial oxidation method). However, according to this method, combustion exhaust gas used for heat generation is mixed into the biomass gasification gas. Therefore, a high-quality biomass gasification gas cannot be obtained.

On the other hand, an external heat type gasification method for obtaining a high calorie and clean fuel gas using biomass has been developed. The contents are disclosed in Patent Document 1. The method mainly aims to obtain a required product gas by using biomass as a fuel and as a gasification raw material; burning the fuel biomass to obtain a high-temperature gas; and utilizing the heat to heat raw material biomass under (almost) an oxygen-free condition for gasification.

In the technology disclosed in Patent Document 1, the biomass combustion space and the biomass gasification space are separated from each other; a completely combusted high-temperature gas produced by completely combusting the fuel biomass obtained from the combustion space is supplied to the biomass gasification space; and thereby the heat energy is used to gasify the raw material biomass in the gasification space. In the technology of Patent Document 1, each of the exothermic reaction between the fuel biomass and oxygen in the combustion space and the endothermic reaction of the raw material biomass in the gasification space can be controlled to gasify biomass. Thereby, making it possible to obtain high-quality biomass gasification gas that has not been conventionally obtained.

The biomass gasification gas produced as described by the method above contains a considerable amount of tar. However, the tar component, having different compositions depending on the gasification temperature, is generally a mixture of various organic compounds containing a large amount of aromatic compounds, and is a high-viscosity liquid having high adhesiveness at normal temperature. Therefore, the tar component has been regarded as a troublesome by-product during gasification and has not been actively used.

For example, when a biomass gasification liquid fuel is manufactured, carbon monoxide and hydrogen generated by gasification are reacted with a catalyst to synthesize a liquid fuel such as methanol. At this time, the only necessary chemical species are carbon monoxide and hydrogen, and other chemical species (for example, organic compounds that adversely affect the synthesis catalyst) such as tar are unnecessary.

In addition, when a biomass gasification gas is used as a fuel in a gas engine or the like, organic compounds such as methane, ethylene, or benzene can also be used as a fuel in addition to carbon monoxide and hydrogen. However, organic compound species having high molecular weight and high viscosity causes deterioration in fuel quality, and thus it is necessary to remove and discard them in many cases.

On the other hand, there is an increasing demand to replace petrochemical products such as plastics with CO₂-free products due to the recent trend of prevention of global warming and practical application of CO₂-free technology. As long as fossil fuels are used as raw materials, petrochemical products such as plastics cannot be CO₂-free.

If organic chemical substances derived from biomass, so-called bio-oil, are used as a raw material instead of fossil fuel, CO₂-free petrochemical products can be produced. Although bio-oil using waste edible oil as a raw material has been studied, there is competition with other fuel applications such as fuel for aircraft which limits the amount of resources.

Therefore, if tar, which is a by-product of biomass gasification gas that has not been utilized so far, can be recovered and effectively used as a raw material for plastic or the like instead of fossil fuels, CO₂-free plastic or CO₂-free chemical product can be produced.

It is possible to separate CO₂-free organic compounds into each component, by adding the collectively recovered tar into an existing crude oil distillation and purification system instead of crude oil.

However, when there is a desire to particularly utilize a specific substance in tar, it is preferable to selectively recover the organic compound of interest in tar in the tar recovery process from the gasification gas because less energy is required for fractionation in subsequent steps.

As a technique for recovering tar from the gasification gas, a method and an apparatus for producing a product gas in which tar in a biomass gasification product gas is reduced to an extremely low concentration is described in Patent Document 2. There is a first step of spraying water on a product gas and a second step of bubbling the product gas in water. The apparatus has a third step of cooling the product gas by contacting the gas with the cooling heat transfer surface.

However, the object of the technology described in Patent Document 2 aims to remove tar in a biomass gasification product gas, and does not involve the idea of recovering and effectively utilizing tar.

Patent Document 3 describes a tar-containing gas cleaning method of reducing the content of tar in a tar-containing gas that contains tar and dust, the method includes separating heavy tar with a relatively high boiling point from the tar-containing gas by oil scrubbing, and separating light tar with a relatively low boiling point from the tar-containing gas by water scrubbing. A method is described in which the light tar separated in the water scrubbing step is further utilized as a cleaning oil in the oil scrubbing 4 steps.

However, the technology described in Patent Document 3 aims to effectively use light tar as a cleaning oil for recovering heavy tar but does not disclose a technique for intentionally fractionating and recovering a component with desired boiling point in tar recovery.

Further, Patent Document 4 describes a method of recovering crude light oil components contained in coke oven gas or pyrolysis oven gas, and the method includes an absorption step of absorbing a crude light oil component contained in a gas into an absorbing oil; a recovery step of recovering the light oil component from the absorbing oil after recovery in a distillation tower; and a cooling step of cooling the absorbing oil after recovery in a heat exchanger and then supplying the cooled absorbing oil to the absorption step again. Regarding the temperature of the absorbing oil, in order to efficiently recover the crude light oil components, it is preferable to cool the absorbing oil to a lower temperature and supply the cooled absorbing oil to the absorption tower. On the other hand, when the temperature of the absorbing oil is excessively lowered, there is a problem that dissolved components are precipitated on the inner wall of the cooler or the pipe. For this reason, a method of monitoring the precipitation state in the absorbing oil and adjusting cooling in the heat exchanger depending on precipitation occurrence is presented.

However, the technology described in Patent Document 4 adjusts the cooling temperature of the absorbing oil for preventing precipitation, but does not disclose a technique for intentionally fractionating and recovering a component with desired boiling point in tar recovery.

In order to utilize organic compound species of interest in tar, a technique for selectively and efficiently separating and recovering tar components from a biomass gasification gas, which is covered in the present invention, is required.

### PRIOR ART DOCUMENT

### Patent Documents

Patent Document 1: JP-A-2018-095746
Patent Document 2: JP-A-2014-125577
Patent Document 3: JP-B-3943042
Patent Document 4: JP-B-6672875

### SUMMARY OF THE INVENTION

### The Means to Solve the Problems

In order to solve the above needs, an object of the present invention is to provide a cooling and cleaning apparatus for a biomass gasification gas to be connected to a biomass gasification reaction apparatus not only for utilizing carbon monoxide or hydrogen that are the main components of biomass gasification gas but also for maximally effectively utilizing organic compounds including tar or the like that are other biomass gasification products in order to enable further effective utilization of a biomass gasification product, and a method for using the same.

In one aspect, the present disclosure provides an apparatus for treating a biomass gas obtained by gasifying biomass, the apparatus comprising: a cooling and cleaning unit that cools and cleans the biomass gas with a cleaning liquid; a recovery unit that recovers the cleaning liquid; and a separation unit that extracts tar in the recovered cleaning liquid by specific gravity separation, in which the cooling and cleaning unit comprises: an inlet chamber that initially receives the biomass gas; and an outlet chamber that receives the biomass gas that has passed through the inlet chamber.

Accordingly, the present disclosure provides the following.

### Item 1

An apparatus for treating a biomass gasification gas, the apparatus comprising a plurality of treatment units connected in series to extract organic compounds by treating a biomass gasification gas obtained by gasifying biomass.

in which the treatment unit comprises:
a cooling and cleaning apparatus that sprays a cleaning liquid to cool and clean the biomass gasification gas;
an organic compound separation apparatus that extracts organic compounds from the cleaning liquid used in the cooling and cleaning apparatus; and
a temperature adjusting apparatus that cools the cleaning liquid with increased temperature as the result of the cooling, and
the biomass gasification gas that has been treated in the treatment unit in a preceding stage is further treated in a subsequent stage of the said treatment unit.

### Item 2

The apparatus according to any of the preceding items, wherein a temperature and/or a flow rate of the cleaning liquid in the cooling and cleaning apparatus can be set separately for each of the treatment units.

### Item 3

The apparatus according to any of the preceding items, wherein the organic compounds are dust or tar having a high viscosity at normal temperature, and the organic compound separation apparatus is a specific gravity separation apparatus.

### Item 4

The apparatus according to any of the preceding items, wherein the specific gravity separation apparatus is a centrifuge separator.

### Item 5

The apparatus according to any of the preceding items, wherein the organic compound is a light oil component, and the organic compound separation apparatus is an oil-water separation apparatus.

### Item 6

The apparatus according to any of the preceding items, wherein in the cooling and cleaning apparatus, cooling and cleaning is by passing fine bubbles of the biomass gasification gas generated by an air diffuser through the cleaning liquid.

### Item 7

The apparatus according to any of the preceding items, wherein in the cooling and cleaning apparatus, the cleaning liquid is added with an absorbing agent for absorbing a specific type of organic compound.

### Item 8

The apparatus according to any of the preceding items, wherein in the cooling and cleaning apparatus, the cleaning liquid is added with a coagulant.

### Item 9

The apparatus according to any of the preceding items, wherein in the cooling and cleaning apparatus, an oil having a boiling point higher than 100° C. is used as the cleaning liquid.

### Item 10

The apparatus according to any of the preceding items, wherein the cleaning liquid in at least two treatment units of the plurality of treatment units is a polar solvent.

### Item 11

The apparatus according to any of the preceding items, further comprising an external heat type biomass gasification reaction apparatus in which heat is supplied from the outside of a reaction pipe, and biomass and a gasifying agent in the reaction pipe are reacted to generate a biomass gasification gas, wherein
the biomass gasification gas generated in the external heat type biomass gasification reaction apparatus is treated in the treatment unit to extract organic compounds.

### Item 12

An apparatus for treating a biomass gas obtained by gasifying biomass, the apparatus comprising:
a cooling and cleaning unit that cools and cleans the biomass gas with a cleaning liquid;
a recovery unit that recovers the cleaning liquid; and
a separation unit that extracts tar in the recovered cleaning liquid by specific gravity separation,
wherein
the cooling and cleaning unit comprises:
an inlet chamber that initially receives the biomass gas; and
an outlet chamber that receives the biomass gas that has passed through the inlet chamber.

### Item 13

The apparatus according to any of the preceding items, wherein the biomass gas having a temperature of 500° C. or higher is supplied to the inlet chamber.

### Item 14

The apparatus according to any of the preceding items, wherein the biomass gas is cooled to a temperature of 200° C. or lower in the inlet chamber.

### Item 15

The apparatus according to any of the preceding items, wherein the inlet chamber comprises a spray nozzle to spray the cleaning liquid to the biomass gas.

### Item 16

The apparatus according to any of the preceding items, wherein a cleaning liquid having a temperature lower than a temperature of a cleaning liquid to be sprayed into the inlet chamber is sprayed into the outlet chamber.

### Item 17

The apparatus according to any of the preceding items, wherein the cleaning liquid in an amount of about 10 to 50 L/Nm³ is supplied to the biomass gas in the inlet chamber.

### Item 18

The apparatus according to any of the preceding items, wherein the biomass gas is cooled to 20° C. or lower in the outlet chamber.

### Item 19

The apparatus according to any of the preceding items, wherein the inlet chamber is supplied with the biomass gas containing about 5 to 20 g/m³ of tar.

### Item 20

The apparatus according to any of the preceding items, wherein each chamber of the cooling and cleaning unit is free of filler.

### Item 21

The apparatus according to any of the preceding items, further comprises one or more chambers between the inlet chamber and the outlet chamber.

### Item 22

The apparatus according to any of the preceding items, wherein adjacent chambers in the cooling and cleaning unit are connected to each other through an opening.

### Item 23

The apparatus according to any of the preceding items, wherein the separation unit has a centrifuge separator.

### Item 24

The apparatus according to any of the preceding items, wherein the recovery unit has a plurality of subunits that separately recover cleaning liquids from different chambers in the cooling and cleaning unit.

### Item 25

The apparatus according to any of the preceding items, comprising a channel that delivers the cleaning liquid passing through the separation unit and deprived of tar to the cooling and cleaning unit.

### Item 26

The apparatus according to any of the preceding items, wherein the cooling and cleaning unit comprises an air diffuser that generates fine bubbles of the biomass gas into the cleaning liquid.

### Item 27

A method for obtaining tar from biomass gas obtained by gasifying biomass, the method comprising:
cooling and cleaning the biomass gas with a cleaning liquid in a cooling and cleaning unit;
recovering the cleaning liquid in a recovery unit; and
extracting tar in the recovered cleaning liquid by specific gravity separation in a separation unit,
wherein
the cooling and cleaning unit comprises:
an inlet chamber that initially receives the biomass gas; and
an outlet chamber that receives the biomass gas that has passed through the inlet chamber.

### Item 28

Tar obtained by the method according to any of the preceding items.

In the present disclosure, it is intended that one or more features described above may be provided in further combination in addition to the specifically described combination. It should be noted that further embodiments and advantages of the present disclosure will be appreciated by those skilled in the art upon reading and understanding the following detailed description as necessary.

### ADVANTAGES OF THE INVENTION

When a biomass gasification reaction apparatus and the biomass gas treatment apparatus of the present disclosure are combined, an organic compound to be recovered can be recovered (with an appropriate selectivity) from a biomass gas.

The biomass gasification method is not particularly limited, but the external heat type biomass gasification reactor as disclosed in Patent Document 1 is most suitable. This is because, in the external heat type biomass gasification reactor, the gasification conditions (such as the gasification temperature) can be adjusted to change the composition of tar produced as a by-product in gasification. When the gasification conditions in the external heat type biomass gasification reactor is adjusted so that tar containing desired organic compound species in a larger amount is produced as a by-product, and the tar is Selectively recovered with the biomass gas treatment apparatus of the present disclosure, a tar component that is a CO2-free and biomass-derived chemical raw material product can be efficiently obtained at low cost simultaneously with a useful biomass gas.

### BRIEF DESCRIPTION OF THE DRAWINGS

FIG. 1 is a schematic diagram illustrating the basic configuration of an embodiment of a biomass gas cooling and cleaning and chemical substance recovery apparatus of the present disclosure.

FIG. 2 is a schematic diagram illustrating an embodiment of an external heat type biomass gasification reaction apparatus 101.

FIG. 3 is a schematic diagram illustrating an exemplary configuration of a biomass gas cooling and cleaning apparatus of the present disclosure. The arrows represent the flow of a biomass gas.

### EMBODIMENTS OF THE INVENTION

Hereinafter, definitions and/or basic technical contents of terms particularly used in the specification will be described as appropriate.

### Definitions and the Like

As used herein, the “tar” refers to a mixture of plurality kinds of organic compounds in a state of a liquid to solid that is viscous at normal temperature, and is usually colored black to brown, and contains carbon as the main constituent element.

As used herein, the “unit” refers to a physical structure having a specific function. Since a structure may have a plurality of functions, a unit having a function of A and a unit having a function of B may form an integrated structure. For example, in the cooling and cleaning unit of the present disclosure, a cleaning liquid may be gathered at the bottom of the chamber. Therefore, a part of the chamber may constitute a part of the recovery unit.

As used herein, the term “about” refers to plus or minus 10% from the indicated value, unless otherwise defined.

### Preferred Embodiment

Preferred embodiments of the present disclosure will be described below. It is understood that the embodiments below are provided for a better understanding of the present disclosure, and the scope of the present disclosure should not be limited to the following description. Therefore, it is apparent that those skilled in the art can appropriately make modifications within the scope of the present disclosure in view of the description in the specification. In addition, it is understood that the following embodiments of the present disclosure can be used alone or in combination thereof.

In one aspect, the present disclosure provides an apparatus for treating a biomass gas obtained by gasifying biomass (herein, also referred to as “the apparatus of the present disclosure”), the apparatus comprising: a cooling and cleaning unit that cools and cleans the biomass gas with a cleaning liquid; a recovery unit that recovers the cleaning liquid; and a separation unit that extracts tar in the recovered cleaning liquid by specific gravity separation, wherein the cooling and cleaning unit comprises: an inlet chamber that initially receives the biomass gas; and an outlet chamber that receives the biomass gas that has passed through the inlet chamber. The apparatus of the present disclosure can be used in connection with other apparatuses such as a gasification reactor that generates a biomass gas and a gas recovery apparatus that recovers a biomass gas. Also provided herein is a system formed by a combination of the apparatus of the present disclosure and these other apparatuses.

The biomass gas supplied to the apparatus of the present disclosure can be obtained from a gasification reactor that gasifies a biomass raw material. The biomass raw materials for gasification are not particularly limited. For example, barks, foliage, construction waste, agricultural residues such as rice straw, residues from beverage production including beer, and used biomass (food) based oils can be used. The gasification reactor as disclosed in Patent Document 1 can generate a biomass gas from various biomass raw materials. Here, the components contained in the biomass gas to be generated may vary depending on the type of biomass raw material. For example, when a biomass raw material containing chlorine (Cl) is gasified, the generated biomass gas also contains chlorine. In an embodiment, the apparatus of the present disclosure is supplied with a biomass gas containing chlorine element in an amount of about 100 to 10000 ppm, for example, about 100 to 7000 ppm, about 100 to 5000 ppm, about 100 to 2000 ppm, about 100 to 1500 ppm, about 100 to 1000 ppm, about 150 to 10000 ppm, about 150 to 7000 ppm, about 150 to 5000 ppm, about 150 to 2000 ppm, about 150 to 1500 ppm, about 150 to 1000 ppm, about 200 to 10000 ppm, about 200 to 7000 ppm, about 200 to 5000 ppm, about 200 to 2000 ppm, about 200 to 1500 ppm, about 200 to 1000 ppm, about 500 to 10000 ppm, about 500 to 7000 ppm, about 500 to 5000 ppm, about 500 to 2000 ppm, about 500 to 1500 ppm, about 700 to 10000 ppm, about 700 to 7000 ppm, about 700 to 5000 ppm, about 700 to 2000 ppm, or about 700 to 1500 ppm. It was confirmed that a biomass gas containing about 1000 ppm of chlorine element can be treated by the apparatus of the present disclosure (data not shown). Since a biomass gas having a low chlorine content is more easily treated, the apparatus of the present disclosure can also treat a biomass gas having a chlorine content below the above numerical values.

For example, chlorine contained in a biomass gas causes generation of harmful substances such as dioxin. Dioxin is generated particularly abundantly in a temperature range of about 500° C. to about 250° C., and therefore it is preferable that the biomass gas is not maintained in such a temperature range for a long time. From a hot biomass gas immediately after passing through the gasification reactor, heat energy can be extracted using a heat exchanger or the like. However, the process generally involves a slow temperature drop of the biomass gas. Therefore, in an embodiment, no heat exchanger is installed between the apparatus of the present disclosure and the gasification reactor. In an embodiment, the apparatus of the present disclosure may comprise stainless steel base materials such as SS and SUS based ones to have high corrosion resistance to chlorine.

In an embodiment, a high temperature biomass gas is supplied to the inlet chamber of the apparatus of the present disclosure. In an embodiment, the apparatus of the present disclosure is supplied with a biomass gas having a temperature of about 1500° C. to about 300° C., for example, about 300° C. or more, about 400° C. or more, about 500° C. or more, about 550° C. or more, about 600° C. or more, about 650° C. or more, about 700° C. or more, about 750° C. or more, or about 800° C. or more.

In an embodiment, in the inlet chamber of the apparatus of the present disclosure, the biomass gas is cooled to about 250° C. to about 80° C., for example, about 250° C. or less, about 200° C. or less, about 180° C. or less, about 160° C. or less, about 140° C. or less, about 120° C. or less, or about 100° C. or less. It may be advantageous to rapidly cool the biomass gas to shorten the retention time in the temperature range where harmful substances such as dioxin are produced.

In one or more chambers of the cooling and cleaning unit of the apparatus of the present disclosure, the biomass gas is cooled and cleaned by a cleaning liquid. In particular, in the inlet chamber, cooling and cleaning with a cleaning liquid are preferably performed in order to rapidly cool the biomass gas. In an embodiment, in the cooling and cleaning unit of the apparatus of the present disclosure, the chamber (such as the inlet chamber) comprises a spray nozzle to spray a cleaning liquid to the biomass gas. In an embodiment, the droplet size (average particle size or mode particle size) of the sprayed cleaning liquid may be about 40 to 4000 μm, for example, about 40 to 2000 μm, about 40 to 1000 μm, about 40 to 800 μm, about 40 to 600 μm, about 40 to 400 μm, about 70 to 4000 μm, about 70 to 2000 μm, about 70 to 1000 μm, about 70 to 800 μm, about 70 to 600 μm, about 70 to 400 μm, about 100 to 4000 μm, about 100 to 2000 μm, about 100 to 1000 μm, about 100 to 800 μm, about 100 to 600 μm, about 100 to 400 μm, about 150 to 4000 μm, about 150 to 2000 μm, about 150 to 1000 μm, about 150 to 800 μm, about 150 to 600 μm, about 150 to 400 μm, about 200 to 4000 μm, about 200 to 2000 μm, about 200 to 1000 μm, about 200 to 800 μm, about 200 to 600 μm, about 400 to 4000 μm, about 400 to 2000 μm, about 400 to 1000 μm, or about 400 to 800 μm. In the apparatus of the present disclosure, a large amount of tar was successfully recovered when a cleaning liquid was sprayed as a droplet with a particle size of about 200 to 600 μm, particularly about 400 μm (data not shown). A droplet with such a particle size can also function as an aggregation core for vaporized tar components.

In an embodiment, in the chamber (such as the inlet chamber) of the cooling and cleaning unit of the apparatus of the present disclosure, a cleaning liquid is supplied in an amount of about 5 to about 1000 L/Nm³, for example, about 5 to about 700 L/Nm³, about 5 to about 500 L/Nm³, about 5 to about 200 L/Nm³, about 5 to about 150 L/Nm³, about 5 to about 100 L/Nm³, about 5 to about 50 L/Nm³, about 15 to about 1000 L/Nm³, about 10 to about 700 L/Nm³, about 10 to about 500 L/Nm³, about 10 to about 200 L/Nm³, about 10 to about 150 L/Nm³, about 10 to about 100 L/Nm³, about 10 to about 50 L/Nm³, about 15 to about 1000 L/Nm³, about 15 to about 700 L/Nm³, about 15 to about 500 L/Nm³, about 15 to about 200 L/Nm³, about 15 to about 150 L/Nm³, about 15 to about 100 L/Nm³, about 15 to about 50 L/Nm³, about 20 to about 1000 L/Nm³, about 20 to about 700 L/Nm³, about 20 to about 500 L/Nm³, about 20 to about 200 L/Nm³, about 20 to about 150 L/Nm³, about 20 to about 100 L/Nm³, about 20 to about 50 L/Nm³, about 30 to about 1000 L/Nm³, about 30 to about 700 L/Nm³, about 30 to about 500 L/Nm³, about 30 to about 200 L/Nm³, about 30 to about 150 L/Nm³, about 30 to about 100 L/Nm³, about 50 to about 1000 L/Nm³, about 50 to about 700 L/Nm³, about 50 to about 500 L/Nm³, about 50 to about 200 L/Nm³, about 50 to about 150 L/Nm³, about 70 to about 1000 L/Nm³, about 70 to about 700 L/Nm³, about 70 to about 500 L/Nm³, about 70 to about 200 L/Nm³, or about 70 to about 150 L/Nm³ of the biomass gas.

In an embodiment, in the chamber (such as the inlet chamber) of the cooling and cleaning unit of the apparatus of the present disclosure, a cleaning liquid is supplied at about 50 Nm³/h is supplied in an amount of about 2 to about 500 L/min, for example, about 2 to about 300 L/min, about 2 to about 200 L/min, about 2 to about 150 L/min, about 2 to about 100 L/min, about 2 to about 70 L/min, about 2 to about 50 L/min, about 2 to about 30 L/min, about 2 to about 20 L/min, about 5 to about 500 L/min, about 5 to about 200 L/min, about 5 to about 150 L/min, about 5 to about 100 L/min, about 5 to about 70 L/min, about 5 to about 50 L/min, about 5 to about 30 L/min, about 5 to about 20 L/min, about 7 to about 500 L/min, about 7 to about 200 L/min, about 7 to about 150 L/min, about 7 to about 100 L/min, about 7 to about 70 L/min, about 7 to about 50 L/min, about 7 to about 30 L/min, about 7 to about 20 L/min, about 10 to about 500 L/min, about 10 to about 200 L/min, about 10 to about 150 L/min, about 10 to about 100 L/min, about 10 to about 70 L/min, about 10 to about 50 L/min, about 10 to about 30 L/min, about 10 to about 20 L/min, about 15 to about 500 L/min, about 15 to about 200 L/min, about 15 to about 150 L/min, about 15 to about 100 L/min, about 15 to about 70 L/min, about 15 to about 50 L/min, about 15 to about 30 L/min, about 20 to about 500 L/min, about 20 to about 200 L/min, about 20 to about 150 L/min, about 20 to about 100 L/min, about 20 to about 70 L/min, about 20 to about 50 L/min, or about 20 to about 30 L/min. The above description represents the relative amount of the cleaning liquid with respect to the biomass gas. It is not intended that the supply rate of the biomass gas is limited to about 50 Nm³/h while the biomass gas is supplied at about 50 Nm³/h. The supply rate of the biomass gas may be, for example, about 5 to 500 Nm³/h, about 10 to 200 Nm³/h, about 20 to 100 Nm³/h, or the like. When the biomass gas was supplied at about 50 Nm³ /h while a cleaning liquid was supplied in an amount of about 20 to 30 L/min in the inlet chamber and in an amount of about 50 to 200 L/min in the entire apparatus of the present disclosure, the biomass gas was successfully cooled in a preferable manner (data not shown).

In an embodiment, the cleaning liquid is substantially comprised of water. For example, about 90% or more, about 92% or more, about 94% or more, about 96% or more, about 98% or more, about 99% or more, or about 99.5% or more by wt % of the cleaning liquid is comprised of water. Water has a large heat capacity and even a relatively small amount of water can cool a biomass gas. In an embodiment, the cleaning liquid is substantially free of organic solvents such as methanol, ethanol, acetonitrile, ethyl acetate, and oils (plant oil, mineral oil) (for example, in an amount of about 2 wt % or less, about 1 wt % or less, about 0.5 wt % or less).

In an embodiment, in the cooling and cleaning unit of the apparatus of the present disclosure, the temperature of a cleaning liquid supplied to the chamber may be about 50° C. to about 0° C., for example, about 40° C. to about 0° C., about 30° C. to about 0° C., about 25° C. to about 0° C., about 20° C. to about 0° C., about 15° C. to about 0° C., about 10° C. to about 0° C., about 50° C. to about 5° C., about 40° C. to about 5° C., about 30° C. to about 5° C., about 25° C. to about 5° C., about 20° C. to about 5° C., about 15° C. to about 5° C., about 10° C. to about 5° C., about 50° C. to about 10° C., about 40° C. to about 10° C., about 30° C. to about 10° C., about 25° C. to about 10° C., about 20° C. to about 10° C., about 15° C. to about 10° C., about 50° C. to about 15° C., about 40° C. to about 15° C., about 30° C. to about 15° C., about 25° C. to about 15° C., about 20° C. to about 15° C., about 50° C. to about 20° C., about 40° C. to about 20° C., about 30° C. to about 20° C., or about 25° C. to about 20° C.

In a typical embodiment, the biomass gas is cooled to a lower temperature in a later chamber in the cooling and cleaning unit. The biomass gas comprises various organic compounds having various boiling points, and typically, a compound having a larger molecular weight has a higher boiling point. Therefore, as the biomass gas is cooled, a large amount of tar can be generated. Therefore, it may be advantageous to generate tar in a plurality of chambers and remove tar from the biomass gas in step wise manner to ultimately obtain a biomass gas having a low tar content. In an embodiment, in the apparatus of the present disclosure, the cooling and cleaning unit may comprise one or more chambers between the inlet chamber and the outlet chamber. In this embodiment, after passing through the inlet chamber, the biomass gas passes through the one or more chambers, and then is received in the outlet chamber.

The apparatus of the present disclosure may be supplied with a biomass gas containing a relatively large amount of tar (for example, the amount of tar per biomass gas is about 2 to 50 g/m³, about 2 g/m³, about 3 g/m³, about 4 g/m³, about 5 g/m³, about 7 g/m³, about 10 g/m³, about 15 g/m³, about 20 g/m³, about 25 g/m³, about 30 g/m³, about 35 g/m³, about 40 g/m³, about 45 g/m³, or about 50 g/m³). Therefore, a configuration capable of efficiently removing and recovering tar can be advantageous. With the apparatus of the present disclosure, a biomass gas containing about 10 g/m³ of tar was treated to successfully reduce the tar amount by about 10 fold (data not shown).

When a biomass gas is passed through an apparatus at a subsequent stage after biomass gasification, for example, a methanol synthesis catalyst reaction apparatus, it may be advantageous to cool the biomass gas to an appropriate temperature, remove dust comprising fine particles such as ash, and remove harmful organic compound components, from the viewpoint of stable operation of the catalyst.

Tar deposited in the apparatus can cause physical clogging of the apparatus. Therefore, the apparatus of the present disclosure preferably has a structure in which clogging by tar is reduced. In an embodiment, in the cooling and cleaning unit of the apparatus of the present disclosure, one or more chambers are free of filler. For example, the chamber comprises a hollow region where no structures are disposed, and for example, the ratio of the hollow region in the inner volume of the chamber is about 30% or more, about 50% or more, about 70% or more, or the like. In an embodiment, in the cooling and cleaning unit of the apparatus of the present disclosure, at least one pair of adjacent chambers communicate with each other not through a pipe but through an opening (window). The opening may be, for example, a continuous region provided in a chamber wall where no structure is present, ranging over an area of about 50 cm² or more, about 100 cm² or more, about 150 cm² or more, about 200 cm² or more, about 300 cm² or more, about 400 cm² or more, about 500 cm² or more, about 600 cm² or more, about 700 cm² or more, about 800 cm² or more, about 900 cm² or more, about 1000 cm² or more, about 1500 cm² or more, about 2000 cm² or more, about 3000 cm² or more, or about 5000 cm² or more. In fact, when an opening of 500 mm×600 mm was provided between chambers, there was substantially no clogging with tar (data not shown).

Furthermore, the compounds contained in the biomass gas (tar or the like) can be aggregated in different temperature regions, and separately recovered. Thereby, purification can be performed simultaneously with recovery. In an embodiment, in each of the chambers other than the inlet chamber (such as the outlet chamber) of the cooling and cleaning unit of the apparatus of the present disclosure, the biomass gas may be cooled to about 150° C. or less, about 140° C. or less, about 130° C. or less, about 120° C. or less, about 110° C. or less, about 100° C. or less, about 100° C. or less, about 90° C. or less, about 80° C. or less, about 70° C. or less, about 60° C. or less, about 50° C. or less, about 40° C. or less, about 30° C. or less, about 20° C. or less, or about 10° C. or less. The biomass gas may be cooled to still lower temperatures. In an embodiment, in the outlet chamber, the biomass gas is cooled to about 25° C. or less, about 20° C. or less, about 15° C. or less, about 10° C. or less, or about 5° C. or less. Thereby, a large amount of naphthalene can be recovered.

Since the biomass gas does not need to be cooled to the temperature equal to that of the cleaning liquid, the biomass gas can be cooled to different temperatures in each of the chambers using a cleaning liquid having an equal temperature. However, cleaning liquids having different temperatures may be supplied to each of the chambers. In an embodiment, the temperature of the cleaning liquid supplied into the outlet chamber is set to be lower than the temperature of the cleaning liquid supplied into the inlet chamber.

In an embodiment, in the apparatus of the present disclosure, examples of the recovery unit include a liquid gather portion at the bottom of the chamber of the cooling and cleaning unit, a pipe connecting the cooling and cleaning unit and the separation unit. The recovery unit may comprise a pump to send a cleaning liquid. In an embodiment, the recovery unit may comprise a plurality of subunits that separately recover cleaning liquids from different chambers in the cooling and cleaning unit, or may comprise a merging portion that combines cleaning liquids from a plurality of chambers.

In an embodiment, the cleaning liquid contains water, and the separation unit of the apparatus of the present disclosure comprises an oil-water separation apparatus. In an embodiment, the separation unit of the apparatus of the present disclosure comprises a centrifuge separator. Thus, for example, organic compound components highly dispersed and stabilized in the cleaning liquid can be separated.

Since water is less compatible with tar, separation of tar from water can be achieved in high efficiency compared to separation of tar from organic solvents. In an embodiment, the apparatus of the present disclosure comprises a channel that delivers the cleaning liquid passing through the separation unit and deprived of tar to the cooling and cleaning unit, and the cleaning liquid is circulated again. Thereby, reducing the amount of the cleaning liquid containing compounds derived from the biomass gas released into the environment. When a cleaning liquid is sprayed, the presence of solids in the cleaning liquid may cause clogging of the spray nozzle. Therefore, a filter (may be part of the separation unit) may be used in order to further remove particulate components. In an embodiment, the filter contains activated carbon, which can also remove harmful substances, such as HCN or ammonia, in addition to the particulate components.

The apparatus of the present disclosure can recover, in particular, tar in addition to a biomass gas, and may recover other organic compounds (such as low molecular weight organic compounds generated with gasification of biomass).

When there is an organic compound component to be particularly preferentially recovered, during cleaning and recovering by spraying fine droplets of the cleaning liquid, typically water, the component can be selectively recovered by focusing on its boiling point and appropriately adjusting the spray amount and the cooling temperature of the cleaning liquid in the cooling and cleaning unit. For example, when a certain organic compound is to be recovered, in the preceding stage, fine particles and high-boiling-point organic compounds are cleaned and recovered under the condition of a temperature of equal to or higher than the boiling point of the certain organic compound, and then the biomass gas is cleaned under the condition of a temperature equal to lower than the boiling point to recover the certain organic compound. Thereby, a larger amount of the certain organic compound can be recovered in the cleaning liquid. In setting the cooling temperature, it is necessary to pay attention to condensation and precipitation of organic compounds. When the biomass gas contains a large amount of a component that is solid (or a liquid close to solid) at normal temperature, and when the cooling pipe at a temperature below the freezing point of the component comes into contact with the biomass gas before the components are sufficiently recovered and removed from the biomass gas into the cleaning liquid, a clogging trouble may be caused due to precipitation and growth of the solid.

In an embodiment, for example, when it is desired to focus on organic compound recovery at the boiling point of water or higher, an appropriately temperature-controlled oil can be used for cooling and cleaning instead of water. In an embodiment, absorption of a specific type of organic compound can be promoted by adding an appropriate agent to the cleaning liquid. For example, it is possible to promote the absorption of an organic acid by adding an alkali agent, and it is possible to promote the aggregate growth of the recovered organic compound fine particles (tar fine particles) and to facilitate the separation and recovery by adding an aggregating agent.

In an embodiment, the cooling and cleaning unit may comprise an air diffuser that generates fine bubbles of the biomass gas into the cleaning liquid. Organic compounds such as tar in the biomass gas can be captured by the fine bubbles. For example, the air diffuser may be disposed at the bottom of the chamber such that the air diffuser is immersed in the cleaning liquid gathered at the bottom of the chamber, or may be attached to a liquid tank where the biomass gas is blown into the cleaning liquid through a channel extending from the biomass gas outlet of the outlet chamber. The air diffuser can be, for example, an underwater stirrer provided by M Revo Japan Inc. (Tokyo).

The liquid used as the cleaning liquid has an increased temperature due to the sensible heat of the biomass gas. Accordingly, particularly when reused as the cleaning liquid, the temperature of the liquid needs to be adjusted (for example, cooling). The cleaning liquid can be cooled by an arbitrary method, and examples thereof include a method of delivering the liquid through a pipe installed in a normal temperature environment and a method of using a cooler. Different cooling methods may be employed for each of the chambers in the cooling and cleaning unit into which the cleaning liquid is sprayed. For example, in an embodiment, the cleaning liquid supplied to the very high-temperature inlet chamber can exert a sufficient cooling effect even if the temperature of the cleaning liquid is not as low. On the other hand, a cleaning liquid may need to have a temperature lower than normal temperature in the outlet chamber. Therefore, different cooling methods may be used for the cleaning liquid supplied to the inlet chamber and the cleaning liquid supplied to the outlet chamber. Cooling the cleaning liquid to a temperature below normal temperature (for example, about 10° C.) may require energy, but can be useful for recovering a target compound contained in the biomass gas (tar, naphthalene, etc.).

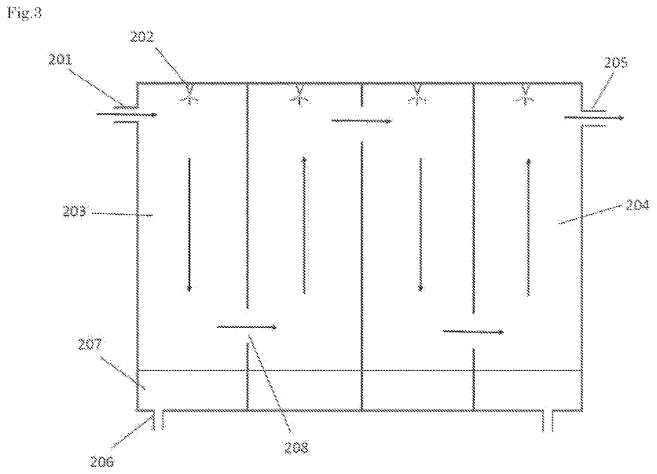

Referring to FIG. 3, which exemplifies a schematic view of the cooling and cleaning unit of the apparatus of the present disclosure, the apparatus of the present disclosure will be further described. The cooling and cleaning unit illustrated in FIG. 3, for example, comprises four chambers. A biomass gas is supplied to an inlet chamber 203 from a biomass gas inlet 201, and the biomass gas that has passed through second and third chambers and an outlet chamber 204 is delivered to the next treatment apparatus out of a biomass gas outlet 205. In an embodiment illustrated in FIG. 3, a spray nozzle is attached to the upper part of each chamber, and the sprayed cleaning liquid moves substantially in the direction of gravity. For example, the amount ratio of the cleaning liquid to be sprayed in respective chamber is about 1:3:3:1, and the temperature of the cleaning liquid to be sprayed is about 30 to 40° C. (inlet chamber 203), about 30 to 40° C. (second chamber), about 10 to 30° C. (third chamber), about 10° C. (outlet chamber 204), and the like. Under such conditions, the temperature of the biomass gas was cooled from about 800° C. to about 100° C. in the inlet chamber, the temperature of the biomass gas was cooled from about 40° C. to below about 20° C. in the outlet chamber, dioxin was generated in a small amount, and a large amount of tar was successfully recovered (data not shown). However, the specific amount ratio and temperature of the cleaning liquid are merely examples, and it is intended that different values can be set depending on the purpose.

In the example illustrated in FIG. 3, the biomass gas inlet 201 and the biomass gas outlet 205 are installed in the upper part of the chamber (upper than the quartile point of the chamber), and the cleaning liquid is less likely to directly flow into the inlet and outlet. The biomass gas may move in the direction of gravity or in the opposite direction thereof in each of the chambers as indicated by the arrows. In FIG. 3, in the inlet chamber 203 and the third chamber, the biomass gas and the cleaning liquid move in the same direction, while they move in the opposite direction (counter flow) in the second chamber and the outlet chamber 204. The inflow position, outflow position, and flow direction of the biomass gas and the cleaning liquid in each chamber are not limited to the specific embodiment illustrated in FIG. 3, and another configuration may be employed. Naturally, an embodiment in which the biomass gas and the cleaning liquid form a counter flow more efficiently and the like are also encompassed in the present disclosure. Tar is generated as the biomass gas is cooled, and a structure such as a filler is not installed in the chamber, and the chambers are connected to each other through openings 208, so that clogging of the cooling and cleaning unit due to tar hardly occurs. The sprayed cleaning liquid may be gathered at the bottom of the chamber (207). The cleaning liquid may be recovered from each chamber, or cleaning liquids from a plurality of chambers may be combined. The composition of tar contained in the cleaning liquid may vary from chamber to chamber. The cleaning liquid is recovered from a cleaning liquid recovery channel 206 and delivered to the Separation unit.

In one aspect, the apparatus of the present disclosure is a biomass gas treatment apparatus comprising a plurality of treatment units connected in series, the treatment unit cooling and cleaning a biomass gas obtained by gasifying biomass, in which the treatment unit comprises: a cooling and cleaning apparatus (cooling and cleaning unit) that sprays fine droplets of cleaning liquid (cooling and cleaning liquid) to the biomass gas for cooling, and at the same time, cleans the biomass gas to recover organic compound components into the cleaning liquid; an organic compound separation apparatus (recovery unit and separation unit) that separates and recovers an organic compound from the cleaning liquid; and a temperature adjusting apparatus that cools the cleaning liquid having an increased temperature after the biomass gas is cleaned, and the biomass gas having been cooled and cleaned in the treatment unit in a preceding stage is further cooled and cleaned in the treatment unit in a subsequent stage.

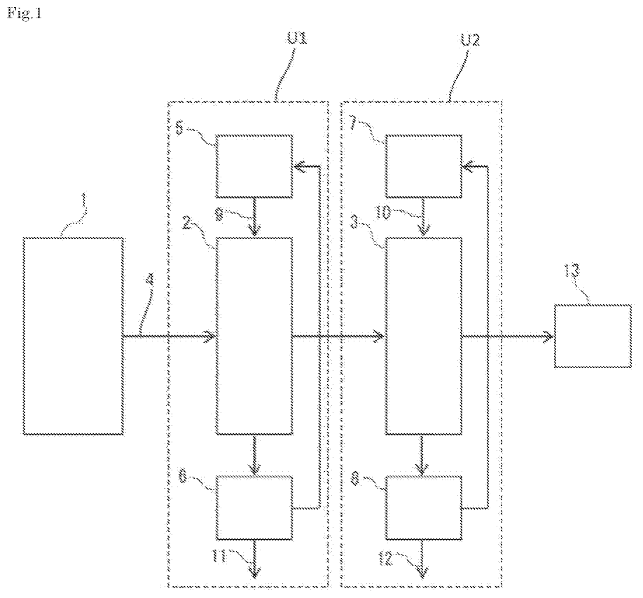

Hereinafter, descriptions will be made with reference to the apparatus of the present disclosure exemplary illustrated in FIG. 1. The biomass gas treatment apparatus according to the embodiment comprises a biomass gasification reaction apparatus 1 and a plurality of treatment units U1 and U2. The biomass gasification reaction apparatus 1 promotes thermochemical endothermic gasification reaction using organic compounds such as biomass or organic waste as a gasified object, that is, a main raw material to obtain a biomass gas 4 containing hydrogen, carbon monoxide, and other organic compounds as components from these raw materials.

The first treatment unit U1 comprises a first cooling and cleaning apparatus (chamber) 2, a separation apparatus (separation unit) 6, and a temperature adjusting apparatus 5. The biomass gas 4 from the biomass gasification reaction apparatus 1 enters the first cooling and cleaning apparatus 2, and is cooled and cleaned in the apparatus by using a cleaning liquid (cooling and cleaning liquid) 9. The first cooling and cleaning apparatus 2 is connected to the separation apparatus 6, and an organic compound (and/or dust) 11 is recovered. The liquid with increased temperature as the result of cooling the biomass gas 4 is cooled in the temperature adjusting apparatus 5, and the cleaning liquid 9 is supplied into the first cooling and cleaning apparatus 2.

In order to cool and clean the biomass gas 4 several times as needed, the second treatment unit U2 is installed at a subsequent stage of the first treatment unit U1. The second treatment unit U2 comprises a second cooling and cleaning apparatus (chamber) 3, a separation apparatus (separation unit) 8, and a temperature adjusting apparatus 7. The biomass gasification gas 4 from the first treatment unit is cooled and cleaned again in the second cooling and cleaning apparatus 3. The second cooling and cleaning apparatus 3 is connected to the separation apparatus 8, and an organic compound (and/or dust) 12 is recovered. The cooling and cleaning liquid having an increased temperature is cooled in the temperature adjusting apparatus 7, and the cooling and cleaning liquid 10 is supplied into the second cooling and cleaning apparatus 3.

The biomass gas 4 after cooling and cleaning is supplied to a biomass gas utilizing facility 13 in a subsequent stage.

It is preferable that the first and second cooling and cleaning apparatuses 2 and 3 have a structure in which fine droplets of cooling and cleaning liquid is sprayed and contacted to the biomass gas 4 from the viewpoint of contact efficiency and pressure loss. In addition, the biomass gas 4 may be bubbled into water in the form of fine bubbles using an appropriate air diffuser.

The temperature adjusting apparatuses 5 and 7 are required to absorb and release a large amount of heat in order to cool and clean the high temperature biomass gas 4. For this purpose, cooling is preferably performed using a cooling tower or the like.

The treatment water for each treatment unit is preferably a polar solvent such as water from the viewpoint of ease of separation between the cleaning water and the organic compound components.

When organic compounds with high viscosity at normal temperature are to be sufficiently removed in advance and a so-called light oil component is to be selectively recovered in a subsequent stage, an oil can be used as the cleaning liquid in the first cooling and cleaning apparatus 2. When the oil temperature is operated at a temperature equal to or higher than the boiling point of water, organic compounds with high viscosity at normal temperature can be preferentially cleaned and removed. In order to separate and recover the organic compounds in this case, it is necessary to combine another method such as distillation.

It is possible to select the organic compound to be recovered by individually setting the type, temperature, and flow rate of the cleaning water for the first and second cooling and cleaning apparatuses 2 and 3.

In the embodiment above, the biomass gasification gas treatment apparatus comprising the two treatment units U1 and U2 has been described, but three or more treatment units may be provided. Each treatment unit may be connected in series. The separation and recovery conditions can be set more precisely by allowing conditions such as the temperature and the flow rate of the cleaning water to be separately set in each treatment unit.

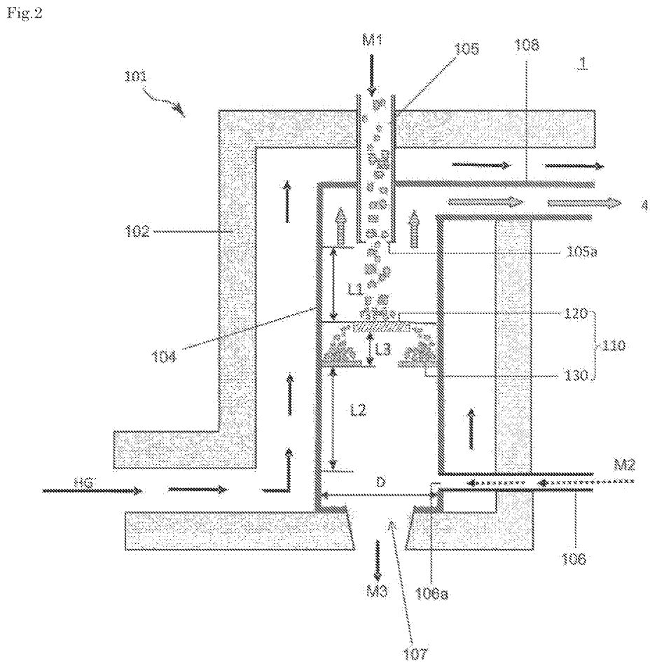

The biomass gasification reaction apparatus 1, which supplies biomass to the apparatus of the present disclosure, is preferably an external heat type biomass gasification reaction apparatus 101 exemplified in FIG. 2.

The external heat type biomass gasification reaction apparatus 101 has a reaction pipe 104 disposed in the space in an outer thermal insulating wall 102. In the reaction space inside the reaction pipe 104, a raw material (biomass) M1 from a raw material introduction pipe 105 and a gasifying agent (water vapor or the like) M2 from a gasifying agent introduction pipe 106 are introduced. Then a biomass gasification gas 4 is produced through a reaction by external heat (heat supplied from the outside of the reaction pipe 104), and is led out from an extraction pipe 108. It is preferable to supply external heat to the reaction space by heating the reaction pipe 104.

In the external heat type biomass gasification reaction apparatus 101, preferably, biomass (coarsely crushed powder) is combusted in a biomass combustion furnace (not shown) or the like to generate a heat gas HG (preferably 800° C. or higher), and the heat gas HG is flowed around the reaction pipe 104 to supply external heat to the reaction pipe 104. Preferably, the counter flow type is adopted, in which the gasifying agent introduction pipe 106 is disposed below the raw material introduction pipe 105, the raw material M1 is supplied from upper to lower, and the gasifying agent M2 is supplied from lower to upper. Preferably, one or more shelf plates 120 and 130 are disposed in the middle of the reaction pipe 104. Preferably, the reaction pipe 104 has a discharge port 107 to discharge reaction residues such as ash M3.

Due to the external heat type, a high-quality biomass gasification gas 4 containing H2 and CO as main components is generated. Furthermore, compared with the partial oxidation method, the biomass gasification gas 4 produced by an external heat type biomass gasification reaction apparatus is gasified in a short time in second. Accordingly, there is a tendency that a tar containing a high percentage of organic compounds of relatively low molecular weight and useful in chemical synthesis or the like such as aromatic compounds, carbonyl compounds, and alcohols is produced in a large amount as a by-product.

Furthermore, in the external heat type biomass gasification reaction apparatus 101, it is possible to control the organic compound species and the component ratio in the biomass gasification gas 4 based on the operating conditions such as the temperature of the heat gas HG and the gasifying agent M2 and the reaction time. For example, using a low temperature such as 900° C. or lower as the gasification temperature allows higher content percentage of low molecular weight organic compounds. Therefore, with a biomass gasification gas treatment apparatus using the external heat type biomass gasification reaction apparatus 101, useful organic compound species can be efficiently extracted.

In one aspect, the present disclosure provides: a method for obtaining tar from a biomass gas obtained by gasifying biomass, the method comprising: cooling and cleaning the biomass gas with a cleaning liquid in a cooling and cleaning unit; recovering the cleaning liquid in a recovery unit; and extracting tar in the recovered cleaning liquid by specific gravity separation in a Separation unit, in which the cooling and cleaning unit comprises: an inlet chamber that initially receives the biomass gas; and an outlet chamber that receives the biomass gas that has passed through the inlet chamber.

In one aspect, the present disclosure provides a tar obtained by the apparatus of the present disclosure or a tar obtained by the method of the present disclosure. Tar is a mixture of organic compounds with a complex composition, which can be difficult to fully analyze. In an embodiment, tar contains naphthalene. Tar is relatively easily separated from water. Accordingly, the water content in tar may be less than about 5 wt %, less than about 2 wt %, less than about 1 wt %, less than about 0.5 wt %, or less than about 0.2 wt %.

Although the present disclosure has been described with reference to preferred embodiments of the present disclosure as above, it is understood that the scope of the present invention should be interpreted only by the claims. It is understood that the patents, patent applications, and other documents cited in the specification are to be incorporated by reference in the specification as if their contents are specifically described in the specification.

### INDUSTRIAL APPLICABILITY

The present disclosure provides an apparatus and a method for separating tar while treating a biomass gas obtained by gasifying biomass, and can provide a product useful in the chemical and energy industries.

### DESCRIPTION OF REFERENCE SIGNS

1 Biomass gasification reaction apparatus
2 First cooling and cleaning apparatus
3 Second cooling and cleaning apparatus
4 Biomass gas
5 Temperature adjusting apparatus
6 Separation apparatus
7 Temperature adjusting apparatus
8 Separation apparatus
9 Cleaning liquid
10 Cleaning liquid
11 Organic compound
12 Organic compound
13 Biomass gas utilizing facility
U1 First treatment unit
U2 Second treatment unit
101 External heat type biomass gasification reaction apparatus
102 Thermal insulating wall
104 Reaction pipe
105 Raw material introduction pipe
106 Gasifying agent introduction pipe
107 Discharge port
108 Extraction pipe
120, 130 Shelf plate
HG Heat gas
M1 Raw material
M2 Gasifying agent
M3 Ash
201 Biomass gas inlet
202 Spray nozzle
203 Inlet chamber
204 Outlet chamber
205 Biomass gas outlet
206 Cleaning liquid recovery channel
207 Cleaning liquid gathered in chamber
208 Opening

1. An apparatus for treating a biomass gas obtained by gasifying biomass, the apparatus comprising:
a cooling and cleaning unit that cools and cleans the biomass gas with a cleaning liquid;
a recovery unit that recovers the cleaning liquid; and
a separation unit that extracts tar in the recovered cleaning liquid by specific gravity separation,
wherein
the cooling and cleaning unit comprises:
an inlet chamber that initially receives the biomass gas; and
an outlet chamber that receives the biomass gas that has passed through the inlet chamber.

2. The apparatus according to claim 1, wherein the biomass gas having a temperature of 500° C. or higher is supplied to the inlet chamber.

3. The apparatus according to claim 1, wherein the biomass gas is cooled to a temperature of 200° C. or lower in the inlet chamber.

4. The apparatus according to claim 1, wherein the inlet chamber comprises a spray nozzle to spray the cleaning liquid to the biomass gas.

5. The apparatus according to claim 1, wherein a cleaning liquid having a temperature lower than a temperature of a cleaning liquid to be sprayed into the inlet chamber is sprayed into the outlet chamber.

6. The apparatus according to claim 1, wherein the cleaning liquid in an amount of about 10 to 50 L/Nm³ is supplied to the biomass gas in the inlet chamber.

7. The apparatus according to claim 1, wherein the biomass gas is cooled to 20° C. or lower in the outlet chamber.

8. The apparatus according to claim 1, wherein the inlet chamber is supplied with the biomass gas containing about 5 to 20 g/m³ of tar.

9. The apparatus according to claim 1, wherein each chamber is free of filler in the cooling and cleaning unit.

10. The apparatus according to claim 1, further comprising one or more chambers between the inlet chamber and the outlet chamber.

11. The apparatus according to claim 1, wherein adjacent chambers communicate with each other through an opening in the cooling and cleaning unit.

12. The apparatus according to claim 1, wherein the separation unit has a centrifuge separator.

13. The apparatus according to claim 1, wherein the recovery unit has a plurality of subunits that separately recover cleaning liquids from different chambers in the cooling and cleaning unit.

14. The apparatus according to claim 1, comprising a channel that delivers the cleaning liquid passing through the separation unit and deprived of tar to the cooling and cleaning unit.

15. The apparatus according to claim 1, wherein the cooling and cleaning unit comprises an air diffuser that generates fine bubbles of the biomass gas into the cleaning liquid.

16. A method for obtaining tar from a biomass gas obtained by gasifying biomass, the method comprising:
cooling and cleaning the biomass gas with a cleaning liquid in a cooling and cleaning unit;
recovering the cleaning liquid in a recovery unit; and
extracting tar in the recovered cleaning liquid by specific gravity separation in a separation unit,
wherein
the cooling and cleaning unit comprises:
an inlet chamber that initially receives the biomass gas; and
an outlet chamber that receives the biomass gas that has passed through the inlet chamber.

17. A tar obtained by the method according to claim 16.
